(19) United States
(12) Patent Application Publication
(10) Pub. No.: US 2015/0247264 A1
(43) Pub. Date: Sep. 3, 2015

(54) CARBON FIBER, MANUFACTURING METHOD AND PROCESSING METHOD THEREOF

(71) Applicant: EMPIRE TECHNOLOGY DEVELOPMENT LLC, Wilmington,, DE (US)

(72) Inventor: Qingkang Wang, Shanghai (CN)

(21) Appl. No.: 14/430,917

(22) PCT Filed: Sep. 26, 2012
(86) PCT No.: PCT/CN2012/082003

§ 371 Date: Mar. 25, 2015

(51) Int. Cl. D01F 9/12; B05D 1/00; B05D 5/00; H01F 1/01

(52) U.S. Cl. CPC D01F 9/12; H01F 1/01; B05D 1/00; B05D 5/00

(57) ABSTRACT

Techniques related to a carbon fiber comprising a magnetic material, methods for making, using and recycling the carbon fiber, are generally described. One example method of making the carbon fiber may include placing the carbon fiber in a solution to form a suspension. The solute includes a metal element of the magnetic material. The example method may further include introducing a gas to contact with the suspension at a first pressure and a first temperature to form a supercritical fluid from the gas and raising the temperature of the carbon fiber to a second temperature.

### BACKGROUND

A carbon fiber reinforced composite material may include a polymer and a carbon fiber. The composite material may be used to substitute for steel because they have similar strengths and hardnesses. However, the weight of the composite material is much less than steel. Therefore, when the composite material is used on a vehicle, the fuel efficiency will be greatly improved. Carbon fiber may be recycled from the composite material with mechanical recycling approaches or chemical recycling approaches. Mechanical recycling approaches may include mincing, grinding and separation. Chemical recycling approaches may include pyrolysis, fluidized bed and combustion. However, such recycling approaches have adoption issues.

### SUMMARY

One embodiment of the disclosure may generally relate to a method for attaching a magnetic material onto carbon fiber. The method comprises placing the carbon fiber in a solution including a solvent and a solute to form a suspension. The solute comprises a metal element of the magnetic material and has a first solubility in the suspension. The method further comprises introducing a gas to contact with the suspension at a first pressure and a first temperature, thereby forming a supercritical fluid from the gas. The solute has a second solubility in the suspension while the existence of the supercritical fluid, and is deposited on the carbon fiber. The method further comprises raising the temperature of the carbon fiber to a second temperature to form a magnetic coating comprising the metal element on the carbon fiber.

Another embodiment of the disclosure may generally relate to a method for extracting carbon fiber from a composite. The method comprises providing a composite that comprises a carbon fiber comprising a magnetic material, dissolving the composite, and collecting the carbon fiber from the composite with a magnet.

Yet another embodiment of the disclosure may generally relate to a carbon fiber comprising a magnetic material.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flow chart 100 illustrating an example method for attaching a magnetic material on carbon fiber;

FIG. 2 is a flow chart 200 illustrating another example method for attaching a magnetic material on carbon fiber; and

FIG. 3 is a flow chart 300 illustrating an example method for extracting carbon fiber from a composite, all arranged in accordance with embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is drawn, among other things, to a carbon fiber comprising a magnetic material, methods for attaching the magnetic material on the carbon fiber, and methods for extracting or recycling the carbon fiber from a composite.

In some embodiments, carbon fibers comprising magnetic material are provided. For example, the carbon fiber is the inorganic polymer fibers about 5-10 μm in diameter and has carbon content higher than 90%. The carbon fiber may contain a magnetic material, for example, a magnetic material attached to the surface of the fiber. The magnetic material may contain one or more metal element(s) for example but without limitation, iron, nickel, cobalt, or a rare earth metal. In some embodiments, the magnetic material is Fe₂O₃ and Fe₃O₄. In some embodiments, the carbon fiber is modified to increase the adhesion of the carbon fiber to the magnetic material, for example, hydroxyl group can attack unsaturated chemical bonds around the carbon fiber surface and therefore to modify the carbon fiber. Methods of attaching a magnetic material on the carbon fiber are described herein. The methods comprise placing the carbon fiber in a solution to form a suspension. The solution includes a solvent and a solute. The solute comprises a metal element of the magnetic material. The solute has a first solubility in the suspension. In some embodiments, the solute includes, without limitation, elements of iron, nickel, cobalt or at least one of rare earth metals. Some example solutes include, without limitation, Fe(NO₃)₃, FeSO₄ and FeCl₃. Some example solvents include, without limitation, water, ethanol, acetone, methanol, isopropanol, limonene and tetrahydrofuran. In some embodiments, the methods further comprise introducing a gas to contact with the suspension at a first pressure and a first temperature to form a supercritical fluid from the gas. The first pressure may be about 6 MPa to about 9 MPa. The first temperature may be about 25 degrees Celsius to about 45 degrees Celsius.

In some embodiments, the solute has a second solubility in the suspension while the supercritical fluid exists. The second solubility of the solute may be less than the first solubility of the solute so that the solute is deposited on the carbon fiber after the gas forms the supercritical fluid. The methods further include raising the temperature of the carbon fiber to a second temperature so that a magnetic coating comprising the metal element is formed on the carbon fiber. The second temperature may be about 100 degrees Celsius to about 300 degrees Celsius. The second temperature may be maintained for about 0.5 hours to about 5 hours. Some example magnetic coatings include, without limitation, α-Fe₂O₃ and Fe₃O₄. In one non-limiting example, the solute is Fe(NO₃)₃ and the magnetic coating is α-Fe₂O₃.

The methods can further comprise modifying the carbon fiber to increase the adhesion of the carbon fiber to the magnetic material. In some embodiments, a hydroxyl group generating compound is introduced to modify the carbon fiber. The hydroxyl group can attack unsaturated chemical bonds around the carbon fiber surface and therefore to modify the carbon fiber

In some embodiments, the methods can further comprise centrifuging the carbon fiber on which the solute is deposited. The carbon fiber and the deposited/attached solute may be separated from the solvent and free solute in the suspension by centrifugation. The centrifuging step may be carried out after the gas is introduced to contact with the suspension and before raising the temperature of the carbon fiber to the second temperature. The methods can further include annealing the carbon fiber and the deposited/attached solute in nitrogen atmosphere after centrifuging. The annealing may be carried out at about 500 degrees Celsius to about 800 degrees Celsius for about 10 minutes to about 1 hour. In one non-limiting example, the solute is Fe(NO₃)₃ and the magnetic coating is Fe₃O₄.

Methods of using the carbon fibers described herein (e.g., carbon fibers that contain magnetic material as described herein) are also provided herein. In some embodiments, the methods include modifying the carbon fiber with an alkyl group containing compound. Some example alkyl group containing compound may include, without limitation, alkyl phosphoric acid and alkyl poly-phosphoric acid. After modification with the alkyl group containing compound, the carbon fiber may include an alkyl group (e.g., —(CH₂)—O—PO₃⁻) on its surface. The alkyl group may facilitate the compatibility of the carbon fiber with a polymer (e.g., polyethylene, polypropylene, polystyrene, etc.). The modified carbon fibers may be incorporated into a composite material to form a carbon fiber reinforced composite material.

Methods of recycling the carbon fiber from a composite containing the carbon fiber are also described herein. The methods can include dissolving the composite and collecting the carbon fiber from the dissolved composite with a magnet. The methods can further include placing the collected carbon fiber between a first surface of a first electromagnetic and a second surface of a second electromagnetic. The first surface comprises a first polarity and the second surface comprises a second polarity. In some embodiments, the first polarity and the second polarity are opposite to each other, for example, the first polarity is the north pole and the second polarity is the south pole. The distance between the first electromagnetic and the second electromagnetic may be configurable. The methods may include moving the second electromagnetic from a first position to a second position, and then back to the first position while the first electromagnetic is still. Such moving may be repeated in multiple rounds. In some embodiments, in each round, the first positions are the same but the second positions are different. For example, the second position in the first round may be closer to the first position than the second position in the second round. The second position may depend on the length and the quantity of the collected carbon fiber.

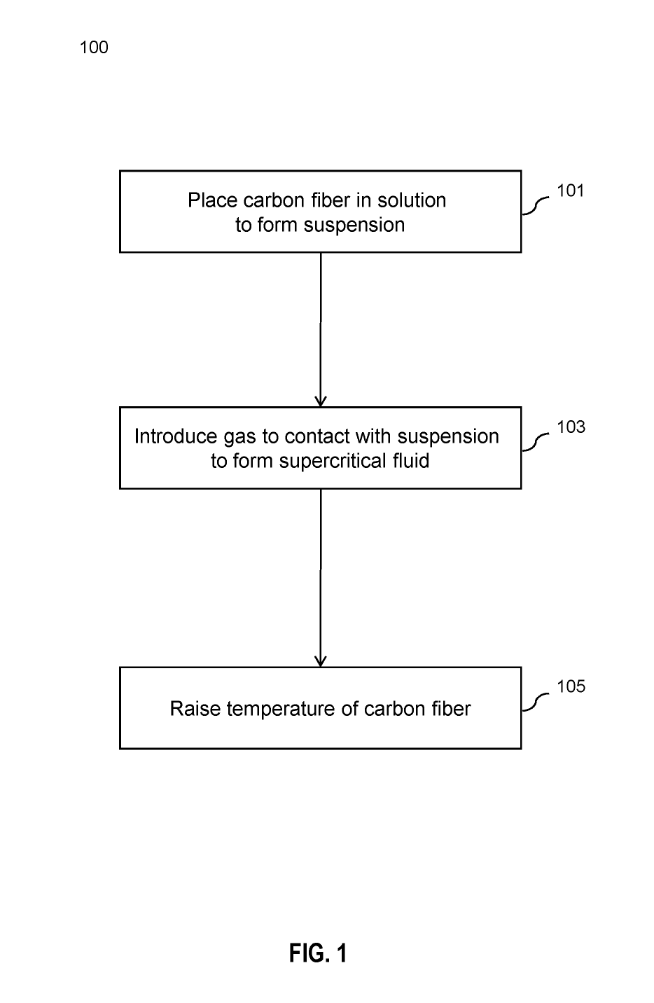

FIG. 1 is a flow chart of an illustrative embodiment of a method 100 for attaching a magnetic material on carbon fiber. The method 100 may begin at block 101 (place carbon fiber in solution to form suspension). The solution includes a solvent and a solute. The solute includes a metal element of the magnetic material and has a first solubility in the suspension. Optionally, the carbon fiber may be modified before placing in the solution. In some embodiments, a Fenton reagent and hydrogen peroxide are used to modify the carbon fiber. The Fe²⁺ ion provided by the Fenton reagent can react with hydrogen peroxide to form a hydroxyl group. As set forth above, the hydroxyl group may modify the carbon fiber.

The method 100 may continue at block 103 (introduce gas to contact with suspension to form supercritical fluid). In some embodiments, a gas is introduced to contact the suspension in a vessel. The gas at a first temperature not less than the critical temperature of the gas keeps introducing in the vessel until the pressure of the gas reaches a first pressure not less than the critical pressure of the gas. Therefore, the gas becomes a supercritical fluid at the first pressure and the first temperature. The supercritical fluid serves as a reagent for inhibiting the dissolution of the solvent. As a result, the solute has a less solubility than the solubility of the solute at block 101 while the supercritical fluid exists. Because of the less solubility, the solute deposits and/or crystallizes on the carbon fiber.

The method 100 may continue at block 105 (raise temperature of carbon fiber). In block 105, the vessel at block 103 is placed in an oven so that the vessel is heated to a second temperature and kept at the second temperature for a period of time. The carbon fiber and the solute deposited/crystallized on the carbon fiber are heated. Therefore, deposited/crystallized solute forms a magnetic coating on the surface of the carbon fiber.

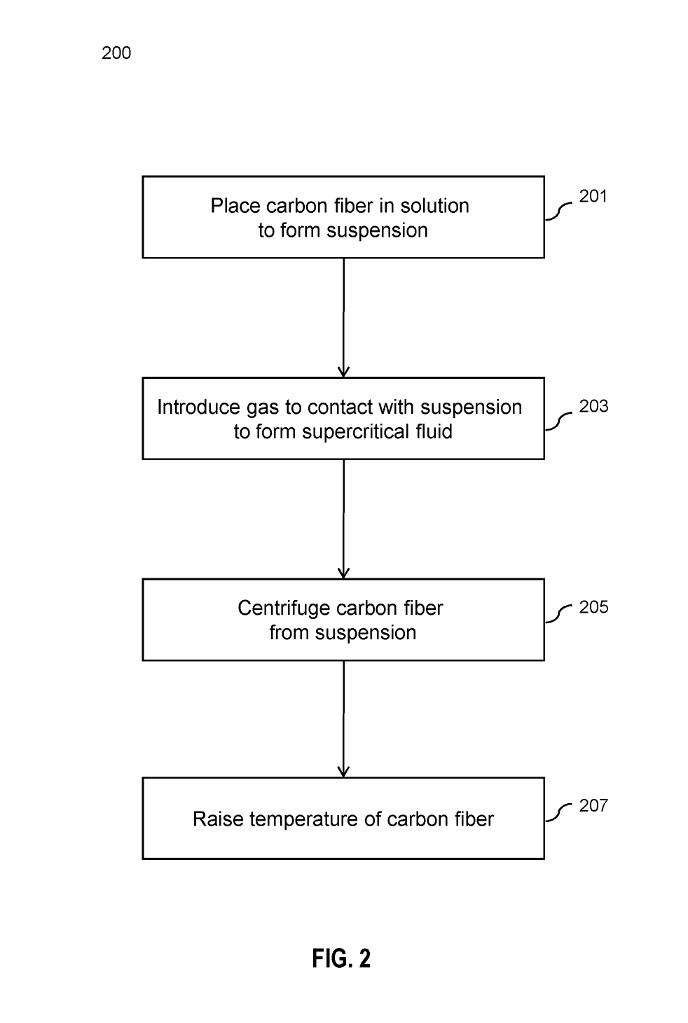

FIG. 2 is a flow chart of an illustrative embodiment of a method 200 for attaching a magnetic material on carbon fiber. The method 200 may begin at block 201 (place carbon fiber in solution to form suspension). The solution includes a solvent and a solute. The solute includes a metal element of the magnetic material and has a first solubility in the suspension. Optionally, the carbon fiber may be modified before placing in the solution. In some embodiments, a Fenton reagent and hydrogen peroxide are used to modify the carbon fiber. The Fe²⁺ ion provided by the Fenton reagent can react with hydrogen peroxide to form a hydroxyl group. As set forth above, the hydroxyl group may modify the carbon fiber.

The method 200 may continue at block 203 (introduce gas to contact with suspension to form supercritical fluid). In some embodiments, a gas is introduced to contact the suspension in a vessel. The gas at a third temperature not less than the critical temperature of the gas keeps introducing in the vessel until the pressure of the gas reaches a third pressure not less than the critical pressure of the gas. Therefore, the gas becomes a supercritical fluid at the third pressure and the third temperature. The supercritical fluid serves as a reagent for inhibiting the dissolution of the solvent. As a result, the solute has a less solubility than the solubility of the solute at block 101 while the supercritical fluid exists. Because of the less solubility, the solute deposits and/or crystallizes on the carbon fiber.

The method 200 may continue at block 205 (centrifuge carbon fiber from suspension). In some embodiments, the vessel in block 203 is centrifuged. After centrifugation, the precipitate is the carbon fiber and the solute deposited/crystallized on the surface of the carbon fiber.

The method 200 may continue at block 207 (raise temperature of carbon fiber). At block 207, the precipitated carbon fiber and the deposited/crystallized solute are heated. In some embodiments, the precipitated carbon fiber and the deposited/crystallized solute are annealed in a nitrogen atmosphere at a fourth temperature for a period of time. The deposited/crystallized solute forms a magnetic coating on the surface of the carbon fiber after annealing.

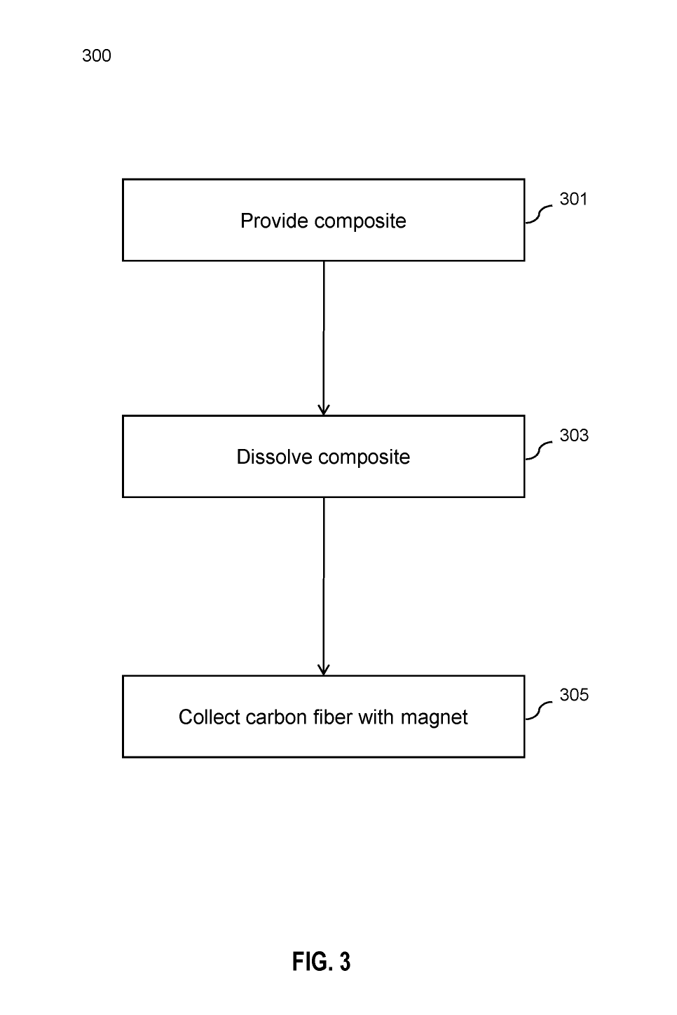

FIG. 3 is a flow chart of an illustrative embodiment of a method 300 for recycling/extracting carbon fiber from a composite. The method 300 may begin at block 301 (provide composite). At block 301, a composite includes the carbon fiber prepared in methods 100 and 200 and a polymer is provided. The polymer may be the matrix of the composite and the carbon fiber prepared in methods 100 and 200 may be the reinforcement. The method 300 may continue at block 303 (dissolve composite). At block 303, the composite is dissolved. The composite may be dissolved by any technical feasible solvent. Some example solvents include, without limitation, acetone, acetic acid, methyl acetate, 2-heptanone, dimethylformamide, benzene, cyclohexane, n-hexane, ethanol, toluene, cholorobenzene, xylene, etc. A mixture of a solvent, the carbon fiber prepared in methods 100 and 200, and a polymer is obtained in block 303 after the composite dissolves in the solvent.

The method 300 may continue at block 305 (collect carbon fiber with magnet). Because the carbon fiber includes a magnetic coating on its surface, the carbon fiber can be collected from the mixture with a magnet.

In some embodiments, the method 300 may further include placing the collected carbon fiber between a first surface of a first electromagnetic and a second surface of a second electromagnetic. The first surface comprises a first polarity and the second surface comprises a second polarity. The first polarity and the second polarity are opposite to each other, for example, the first polarity is the north pole and the second polarity is the south pole. One of the first electromagnetic and the second electromagnetic may be configured to move away from the other and then back to the original position so that the carbon fiber placed between them is stretched and loosened. The stretching and loosening may be repeated in multiple rounds. In each round, one of the electromagnetic moves away from the other electromagnetic and then back to its original position. The distances between the first electromagnetic and the second electromagnetic in each round for stretching the carbon fiber may be different. For example, the distances in each round may be increasing. In some embodiments, the stretched carbon fiber may be modified with an alkyl group containing compound to facilitate the compatibility of the carbon fiber with a polymer when the carbon fiber mixes with the polymer to form a composite.

### EXAMPLES

### Example 1

### Preparation of Carbon Fiber with a Magnetic Coating

Carbon fiber was modified with a Fenton reagent to reduce the surface activation energy of the carbon fiber. Then the carbon fiber was further treated with a solution of hydrogen peroxide and sulfuric acid. The hydroxyl group in the solution may serve as an interface between the magnetic coating and the carbon fiber.

The carbon fiber was then dispersed in a solution of Fe(NO₃)₃ and ethanol to form a suspension. The suspension was placed in a vessel.

CO₂ at about 35 degrees Celsius was introduced to the vessel to contact with the suspension. CO₂ continued to be introduced in the vessel until the pressure of the vessel reached about 7.5 MPa for about 0.5 to 1 hour.

The vessel was then placed in an oven so that the vessel was heated to about 150 degrees of Celsius for about 3 hours so that an α-Fe₂O₃ coating formed on the carbon fiber. The vessel was cooled to the room temperature. The carbon fiber with α-Fe₂O₃ coating was retrieved from the vessel with a magnetic field.

### Example 2

### Preparation of Carbon Fiber with a Magnetic Coating

Carbon fiber was modified with a Fenton reagent to reduce the surface activation energy of the carbon fiber. Then the carbon fiber was further treated with a solution of hydrogen peroxide and sulfuric acid. The hydroxyl group in the solution may serve as an interface between the magnetic coating and the carbon fiber.

The carbon fiber was then dispersed in a solution of Fe(NO₃)₃ and ethanol to form a suspension. The suspension was placed in a vessel.

CO₂ at about 35 degrees Celsius was introduced to the vessel to contact with the suspension. CO₂ continued to be introduced in the vessel until the pressure of the vessel reached about 7.5 MPa for about 0.5 to 1 hour.

The vessel was centrifuged. After centrifugation, the precipitate was the carbon fiber and the deposited/crystallized Fe(NO₃)₃ on the surface of the carbon fiber.

The precipitate was retrieved from the vessel. The precipitate was then annealed in a nitrogen atmosphere at about 600 degrees of Celsius for about 20 minutes so that an Fe₃O₄ coating formed on the carbon fiber. The vessel was cooled to the room temperature. The carbon fiber with Fe₃O₄ coating was retrieved from the vessel with a magnetic field.

### Example 3

### Recycling of Carbon Fiber with a Magnetic Coating

A polyethylene composition including polyethylene as the matrix and carbon fiber prepared in Example 1 or Example 2 as the reinforcement was dissolved in lemonene. After the polyethylene composition was dissolved, a mixture of polyethylene, lemonene and carbon fiber with α-Fe₂O₃ coating or Fe₃O₄ coating was obtained. The carbon fiber with α-Fe₂O₃ coating or Fe₃O₄ coating was then retrieved from the mixture with an electromagnetic.

The retrieved carbon fiber was modified with ethyl phosphoric acid. The ethyl phosphoric acid can facilitate the compatibility of the carbon fiber with another polymer (e.g., polyethylene or polypropylene) so that the modified carbon fiber can be recycled and reformed a composition with another polymer.

### Example 4

### Recycling of Carbon Fiber with a Magnetic Coating

A polypropylene composition including polypropylene as the matrix and carbon fiber prepared in Example 1 or Example 2 as the reinforcement was dissolved in xylene. After the polypropylene composition was dissolved, a mixture of polypropylene, xylene and carbon fiber with α-Fe₂O₃ coating or Fe₃O₄ coating was obtained. The carbon fiber with α-Fe₂O₃ coating or Fe₃O₄ coating was then retrieved from the mixture with a magnetic stirring bar.

The retrieved carbon fiber was modified with ethyl phosphoric acid. The ethyl phosphoric acid can facilitate the compatibility of the carbon fiber with another polymer (e.g., polyethylene or polypropylene) so that the modified carbon fiber can be recycled and reformed a composition with another polymer.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

I/we claim:

1. A method for attaching a magnetic material on carbon fiber, the method comprising:
placing the carbon fiber in a solution including a solvent and a solute to form a suspension, wherein the solute comprises a metal element of the magnetic material, and wherein the solute has a first solubility in the suspension;
introducing a gas to contact with the suspension at a first pressure and a first temperature, thereby forming a supercritical fluid from the gas, wherein the solute has a second solubility in the suspension while the supercritical fluid exists, and wherein the solute is deposited on the carbon fiber; and
raising the temperature of the carbon fiber to a second temperature, wherein a magnetic coating comprising the metal element is formed on the carbon fiber.

2. The method of claim 1, further comprising modifying the carbon fiber prior to the placing step to increase the adhesion to the magnetic material.

3. The method of claim 2, further comprising introducing hydroxyl groups onto the surface and ends of the carbon fiber.

4. The method of claim 1, wherein the second solubility of the solute in the introducing step is less than the first solubility of the solute in the placing step.

5. The method of claim 1, wherein the solute comprises Fe(NO₃)₃.

6. The method of claim 1, wherein the solvent comprises ethanol.

7. The method of claim 1, wherein the first pressure is about 7.5 MPa and the first temperature is about 35 degrees Celsius.

8. The method of claim 7, wherein the second temperature is about 100 degrees Celsius to about 300 degrees Celsius.

9. The method of claim 8, wherein the second temperature is about 150 degrees Celsius.

10. The method of claim 9, wherein the second temperature of about 150 degrees Celsius is maintained for about 0.5 hours to about 5 hours.

11. The method of claim 10, wherein the second temperature of about 150 degrees Celsius is maintained for about 3 hours.

12. The method of claim 10, wherein the solute comprises Fe(NO₃)₃ and the magnetic coating comprises α-Fe₂O₃.

13. The method of claim 1, further comprising centrifuging the carbon fiber comprising deposited solute after the introducing step and before the raising step, thereby separating the carbon fiber from the solvent and free solute in the suspension.

14. The method of claim 13, further comprising annealing the carbon fiber and the deposited solute in nitrogen atmosphere.

15. The method of claim 14, wherein the second temperature is about 500 degrees Celsius to about 800 degrees Celsius.

16. The method of claim 15, wherein the annealing is performed for about 10 minutes to about 1 hour.

17. The method of claim 16, wherein the solute comprises Fe(NO₃)₃ and the magnetic coating comprises Fe₃O₄.

18. A carbon fiber made according to the method of claim 1.

19. A carbon fiber comprising a magnetic material.

20. The carbon fiber of claim 19, wherein the magnetic material comprises α-Fe₂O₃.

21. The carbon fiber of claim 19, wherein the magnetic material comprises Fe₃O₄.

22. A method for extracting carbon fiber from a composite, the method comprising:
providing a composite that comprises a carbon fiber comprising a magnetic material;
dissolving the composite, and
collecting the carbon fiber from the composite with a magnet.

23. The method of claim 22, wherein the magnetic material comprises α-Fe₂O₃.

24. The method of claim 22, wherein the magnetic material comprises Fe₃O₄.

25. The method of claim 22, further comprising placing the collected carbon fiber between a first electromagnet comprising a first polarity and a second electromagnet comprising a second polarity, wherein the first electromagnet and the second electromagnet are separated by a distance.

26. The method of claim 25, wherein the first polarity is opposite to the second polarity.

27. The method of claim 26, wherein the distance between the first electromagnet and the second electromagnet is configurable.

28. The method of claim 27, further comprising increasing the distance between the first electromagnet and the second electromagnet based on the length and/or the amount of the carbon fiber after the carbon fibers are placed between the electromagnets.

29. The method of claim 22, further comprising modifying the surface of the carbon fibers collected from the composite to enhance binding to a polymer.

30. The method of claim 29, wherein the modifying comprises contacting the carbon fibers with alkyl phosphoric acid or alkyl poly-phosphoric acid, thereby forming a —(CH₂)—O—PO₃⁻ functional group on the surface of the carbon fiber, wherein the —CH₂ group is bound to the polymer.
